(19) United States
(12) Patent Application Publication
(10) Pub. No.: US 2006/0069958 A1
(43) Pub. Date: Mar. 30, 2006

(54) Defect location identification for microdevice manufacturing and test

(76) Inventors: Joseph D. Sawicki, Portland, OR (US); John G. Ferguson, Tualatin, OR (US); Sanjay Dhar, Lake Oswego, OR (US); Juan Andres Torres Robles, Wilsonville, OR (US); Janusz Rajski, West Linn, OR (US)

Correspondence Address: BANNER & WITCOFF, LTD., 1001 G STREET, N.W., WASHINGTON, DC, 20001-4597, US

(21) Appl. No.: 11/126,069

(22) Filed: May 9, 2005

Related U.S. Application Data
(60) Provisional application No. 60/569,747, filed on May 9, 2004.

(51) Int. Cl. G06F 11/00

(52) U.S. Cl. 714/33

(57) ABSTRACT

A defect identification tool is disclosed that predicts locations at which defects in a microdevice are most likely to occur. The tool may identify both a type of defect and the particular netlists in which that defect is likely to occur. A test circuit generation tool can then subsequently use this defect information to generate a test circuit that tests for the defect in the identified portions of the microcircuit. Similarly, an automatic test pattern generation tool may use the defect location information to generate test data custom-tailored to check for faults corresponding to the identified defect in the specified portions of the microcircuit. Various implementations of the tool may be used both to identify the locations at which defects caused by systematic errors, such as manufacturing process deficiencies or flaws, are most likely to occur and the locations at which randomly-created defects are most likely to occur.

This application is a continuation application of provisional U.S. Application No. 60/569,747, filed May 9, 2004, entitled “Defect Location Identification For Microdevice Manufacturing and Test” and naming Joseph D. Sawicki, John G. Ferguson, Sanjay Dhar, Juan Andres Torres Robles, and Janusz E. Rajski, as inventors, which provisional patent application is incorporated entirely herein by reference.

### FIELD OF THE INVENTION

The present invention relates to various techniques and tools to assist in the design and testing of microdevices. Various aspects of the present invention are particularly applicable to the identification of potential defect locations in a manufactured microdevice from the microdevice's design.

### BACKGROUND OF THE INVENTION

Microcircuit devices have become commonly used in a variety of products, from automobiles to microwaves to personal computers. As the importance of these devices grows, manufacturers continue to improve these devices. Each year, for example, microcircuit device manufacturers develop new techniques that allow microcircuit devices, such as programmable microprocessors, to be more complex and yet still smaller in size. Moreover, many manufacturers are now employing these techniques to manufacture other types of microdevices, such as optical devices, mechanical machines and static storage devices. These non-electrical microdevices show promise to be as important as microcircuit devices are currently.

Microdevice design software, especially that created for integrated circuit design, can involve many complicated sequences of operations or steps in order to represent a microdevice with various degrees of abstraction. For example, digital integrated circuits (ICs) are generally created initially as a set of abstract logical relationships, and the complex electronic circuits that are needed to represent these logical relationships must be synthesized. These schematic circuit representations comprise collections of “netlists” defining connections of switches, amplifiers, AND, OR, NAND, NOR, and other logic elements that perform specific logic functions or sub-functions. A common circuit representation is the symbolic circuit diagram, as shown in FIG. 1, sometimes also called a circuit schematic.

These symbolic representations must in turn be converted into physical representations that dictate the actual physical dimensions of the transistors and wiring that will be used in the circuit. Often, predefined libraries of these physical representations, corresponding to portions of netlists or even entire netlists, will exist. These predefined representations can then easily be substituted for the various corresponding elements in the schematic representation. These physical representations (or layout designs) are typically multilayer representations, with polygons defined in each layer to create the physical devices needed for achieving the functional goal. For example, logic switches can be made up of transistors created as polysilicon gates formed over active regions of a layer of semiconductor material. Contact holes and vias filled with metal then provide electrical connections from one layer to another, and metal wiring is placed to link one device to another. Logical elements, such as an AND gate, may comprise several transistors. An illustration of a layout for the circuit of FIG. 1 can be found in FIG. 2.

Design workflows typically contain a point at which the layout of the polygons making up these physical representations must be verified against the desired logical netlist. This comparison, for example, insures that the physical representation of a set of wires connecting two elements corresponds to a desired electrical connection in the netlist. This verifications step may be done using, for example, LVS (Layout vs. Schematic (or Source)) software. This type of software typically operates by taking a layout and generating a set of netlists that correspond to the layout. This generated netlist is then compared with the original netlist, from which the layout was originally defined. If the two match to an acceptable degree, the design process proceeds to any other desired verification steps and finally to manufacturing.

Integrated circuit manufacturing is typically carried out layer by layer. The pattern of polygons to be formed is created on a “photomask,” or reticule, and then lithographically reproduced on a wafer of material, such as silicon or gallium arsenide. The integrated circuit (IC) is therefore built up layer by layer, with different masks created to define the specific polygons of each layer.

As microdevices become more complex, they also become more difficult to manufacture. A conventional microcircuit device, for example, may have many millions of connections, and each connection may cause the microcircuit to operate incorrectly or even fail if the connection is not properly made. Accordingly, it is important for a microdevice manufacturer to detect errors in a microdevice before it is provided to a customer or other user, including unintended physical defects. It should be noted that some of ordinary skill in the art sometimes make a distinction between a “defect” that occurs when a specific unintended element accidentally introduced into the manufacturing process (such as a mote of dust or another particle) creates an unintended physical aberration, and the type of error that occurs when intended elements of the circuit are simply incorrectly fabricated. Similarly, some of ordinary skill in the art may sometimes distinguish defects caused by unintended elements introduced during the manufacturing process from post-manufacturing problems with a microdevice, such as when a sub-standard wire shorts out under operation, causing an electrical fault and therefore becoming the source for an electrical “defect” in operation. As used throughout this specification, however, the term “defect”encompasses any unintended physical aberration in a microdevice, and makes no distinction between environmental or particle related defects, desired physical features fabricated at incorrect specifications, and features within specification for dimensional control but nevertheless containing electrical faults or mechanical problems.

Problems in microdevice fabrication that cause a defect can be both systematic and random. Systematic defects will often arise from deficiencies in a manufacturing process. An example of this type of defects is illustrated in FIGS. 3 and 4. More particularly, FIG. 3 illustrates a portion of a microcircuit device 301 that does not have a defect. This portion includes two wiring lines 303 and 305, and three functional structures 307-311. These wiring lines 303 and 305 may belong to completely different netlists for the circuit, even if they happen to be placed in this particular layer in close physical proximity.

While the circuit portion 301 shown in FIG. 3 does not have a defect, a deficiency or flaw in the manufacturing process used to form the circuit portion 301 may create a defect in another manufacturing of the microcircuit. As will be appreciated by those of ordinary skill in the art, the lines 303 and 305 may be formed by a photolithographic process. With this manufacturing process, areas corresponding to lines 303 and 305 are formed on a photomask. Light (or another type of radiation) passing through the photomask is then focused onto conductive material covered with a layer of photosensitive polymer, called photoresist, and the affected portions of the photoresist (or, alternately, the non-affected portions) are removed. The remaining photoresist and conductive material are then placed into a tool for etching. Conductive material which is still covered by the photoresist is not etched, while conductive material where the photoresist has been removed will be etched away. After this etching process, the remaining photoresist is removed, leaving the conducting lines 303 and 305.

If, for example, the photomask used to create the lines 303 and 305 is not accurately positioned, the image of the photomask on the photoresist may be partially out of focus, causing a “bridge” 401 to be subsequently formed between lines 303 and 305, as shown in FIG. 4. The bridge 401 is an unintended physical aberration or defect improperly connecting the functional structures 307 and 309 to the functional structure 311. This defect may in turn cause the circuit 301 to produce erroneous electrical signals or “faults.” For example, if the line 303 is permanently connected to an electrical signal having a logical value of “1,” then the electrical signal carried by the line 305 may likewise be stuck at the logical value of “1.” This type of fault, where an electrical signal carried by one wiring line is erroneously stuck at a particular value due to a bridge with another line, is often referred to as a “stuck-at” fault. A stuck-at fault may result in a continuous signal value, such as when a signal line is bridged to a ground line (a stuck-at “0” fault) or when a signal line is bridged to a power line (a stuck-at “1” fault). Alternately, if a signal line is bridged to another signal line with a more powerful driver, the bridged signal line may experience a dynamic stuck-at fault.

Various defects that may arise from deficiencies or flaws in a manufacturing process, including bridging defects, may occur if any one of a number of lithographic process conditions deviate from ideal. These conditions may include lithographic tool focus, exposure dose setting, positional overlay control, post exposure baking, baking hotplate uniformity, photoresist processing conditions, and other conditions known to those skilled in the art to affect lithographic dimensions. Other process steps, such as plasma etching or metal deposition, have similar variables, such as the plasma composition, vacuum conditions, exposure time, metal sputter target composition, etc. which can lead to variation in the dimensions of the final pattern formed on the wafer.

Random defects may be caused by environmental conditions during the manufacturing process. For example, the bridging defect shown in FIG. 4 also may be produced by air-borne particles in the manufacturing area. More particularly, particles may randomly land on the photomask or wafer during the photolithographic manufacturing process. If a particle of sufficient size lands on the photomask between the areas corresponding to lines 303 and 305, then the bridge 401 can also be formed between the lines 303 and 305.

Various testing procedures have been developed to identify the presence of physical defects in a microdevice, regardless of their origin, by checking for electrical signal faults. According to some conventional testing techniques, (sometimes referred to as “Design-For-Test” techniques) design data for a microcircuit is input into a test generation tool. The test generation tool employs one or more test algorithms to analyze the connectivity described in the design, and then generates a test circuit design for testing the microcircuit. The microcircuit design is then altered by inserting the test circuit design, so that the final manufactured microcircuit will incorporate the test circuit. The test circuit may include, for example, a chain of shift-register circuits (sometimes referred to as a “scan chain”) that allows patterns of test data to be introduced deep into the microcircuit and to read out electrical signal status information resulting from the microcircuit's response to those test patterns. Other test structures will be known to those skilled in the art of Design-For-Test design software.

For some testing techniques, sometimes referred to as “Built-In Self-Test” (BIST) techniques, the test circuit design will randomly generate test data, apply the test data to the microcircuit, and process the test results. With still other testing techniques, sometimes referred to as “deterministic” testing, the test generation tool or an automatic test pattern generation (ATPG) tool will create specialized patterns of test data (sometimes referred to as test vectors) to test the microcircuit. The deterministic test patterns are not generated randomly, but instead are created specifically to test the microcircuit for particular faults. The deterministic test patterns are then applied to the test circuit by automatic test equipment (ATE) to test the microcircuit device.

With both of these techniques, however, only a relatively small portion of the microdevice can be tested. More particularly, because of the number of components on a conventional microcircuit, testing every component would be impractical. Instead, typically only a small percentage of components of a microdevice are tested in an effort to determine the overall reliability of the microdevice. It would therefore be advantageous to better identify which components of a microdevice are more likely to have defects, to ensure that these components are among the selection of tested components. Moreover, it would be useful to determine what types defects these components are likely to have, in order to ensure that these components are tested for the presence of these types of defects.

Still further, the test locations in a microcircuit are selected based upon connectivity information in the microcircuit design. That is, the test locations are selected based upon interconnections between the components described in the microcircuit design, without consideration of the actual location of the defects. For many circuit arrangements, however, the test location may determine whether a fault can be detected. For example, FIG. 5 illustrates a circuit 501 having an input 501 and three NAND gates 505-507. The circuit also has two wiring lines 511 and 513, which are bridged by an AND-type bridging defect 515.

The bridging defect is detected if, for example, a “stuck-at” fault with a value of “0” is detected on line 313 while the value of the signal on line 311 is likewise set to “0.” However, for this “stuck-at-0” fault to be detected at circuit location 317, the value of the signal on line 311 must be set to a value of “1.” Thus, the bridging defect cannot be excited. By the same token, if a test circuit only tests circuit location 317 for the occurrence of a “stuck-at-0” fault on line 313, the tester may not realize that a bridging defect 315 exists that may cause faults to be produced at circuit location 319. Accordingly, a “stuck-at-0” fault revealing the bridging defect 315 must be detected at circuit location 319 or on line 313 itself. This type of point sensitive detection of defects is discussed in more detail in “Impact Of Multiple-Detect Test Patterns On Product Quality,” Brady Benware et al., International Test Conference, IEEE, 2003, which article is incorporated entirely herein by reference. It would therefore be advantageous to identify the locations in a microdevice where defects are more likely to occur, to ensure that the microdevice is properly tested to identify any actual defects at these locations.

### BRIEF SUMMARY OF THE INVENTION

Advantageously, various examples of the invention provide tools and techniques for predicting locations at which defects in a microdevice are more likely to occur. Using this information, the tool may identify both a type of defect and the specific circuit portions in which that defect is more likely to occur. This information may then be provided to a test circuit generation tool and/or an automatic test pattern generation tool. For example, various embodiments of the invention may provide a test circuit generation tool or automatic test pattern generation tool with netlist names identifying the netlists corresponding to the portions of the circuit more likely to have a defect upon manufacture. Some embodiments of the invention may also provide the test circuit generation tool and/or an automatic test pattern generation tool with the types of defects that are more likely to occur at the identified portions of the microcircuit.

Using this defect information, the circuit generation tool can then generate a test circuit that applies a defect-specific test to check for faults in the identified portions of the microcircuit. Similarly, an automatic test pattern generation tool may use the defect location and/or type information itself to generate test data custom-tailored to check for faults corresponding to the identified defect in the identified portions of the microcircuit. With some examples of the invention, the tools or techniques may identify the locations at which defects caused by systematic errors, such as manufacturing process variations, deficiencies or flaws, are more likely to occur. With still other examples of the invention, the tool or techniques may identify the locations which may be the most susceptible to randomly-created defects.

### BRIEF DESCRIPTION OF THE DRAWINGS

FIG. 1 illustrates a schematic design for a circuit.

FIG. 2 illustrates a layout design corresponding to the schematic design shown in FIG. 1.

FIG. 3 illustrates a portion of a circuit without defects.

FIG. 4 illustrates the circuit portion of FIG. 3 with a bridge defect.

FIG. 5 illustrates a circuit arrangement demonstrating the relevance of test locations.

FIG. 6 illustrates a tool according to various embodiments of the invention for identifying locations at which defects in a microdevice are most likely to occur.

FIG. 7A illustrates a three-dimensional graph showing boundary points for an optical manufacturing process.

FIG. 7B illustrates an optical manufacturing process model based upon the boundary points illustrated in FIG. 5.

FIG. 8 illustrates the determination of critical areas for the formation of bridges from incident particles.

FIG. 9 illustrates the impact of using forbidden pitches in a manufacturing process.

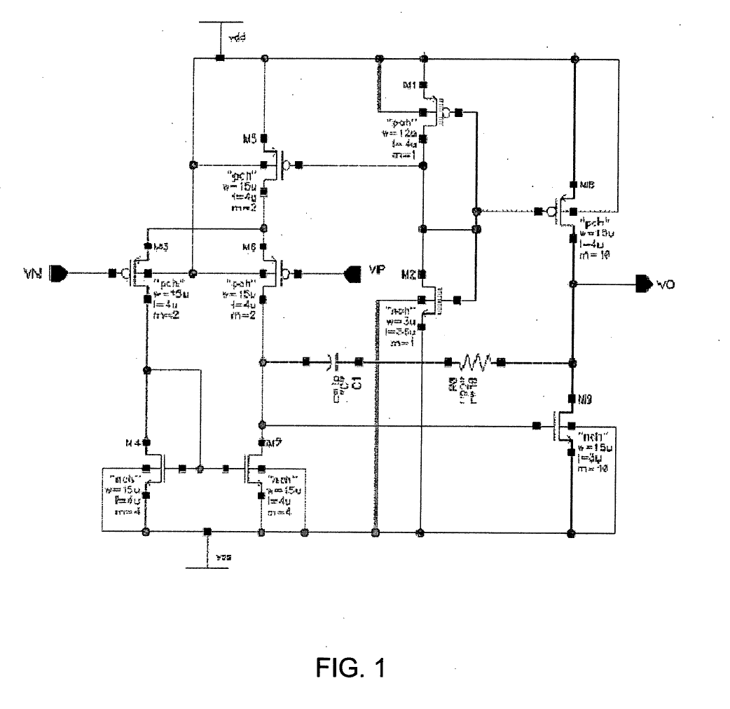

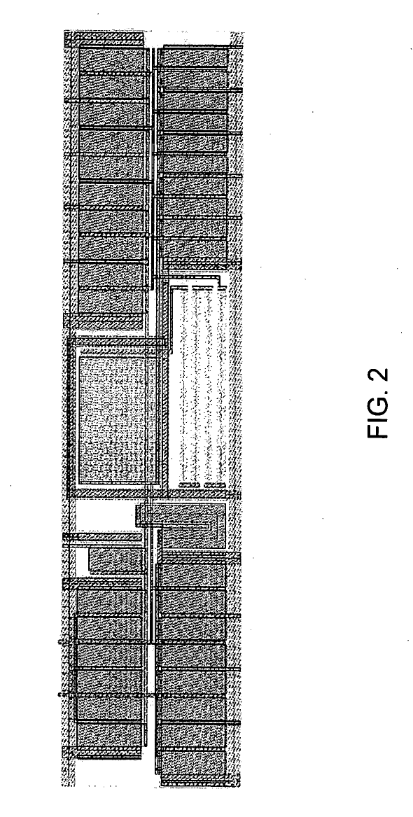

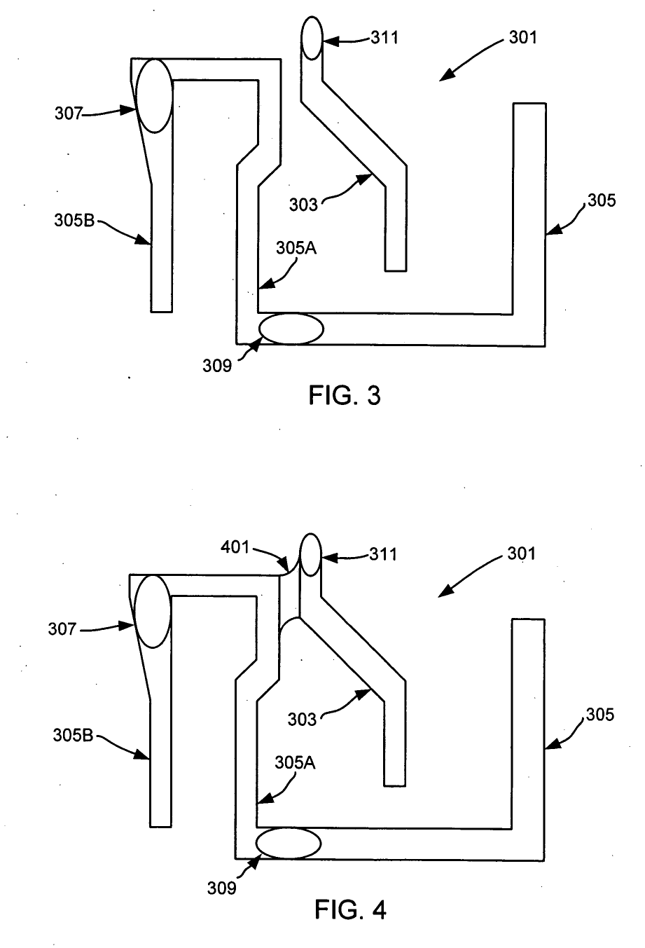

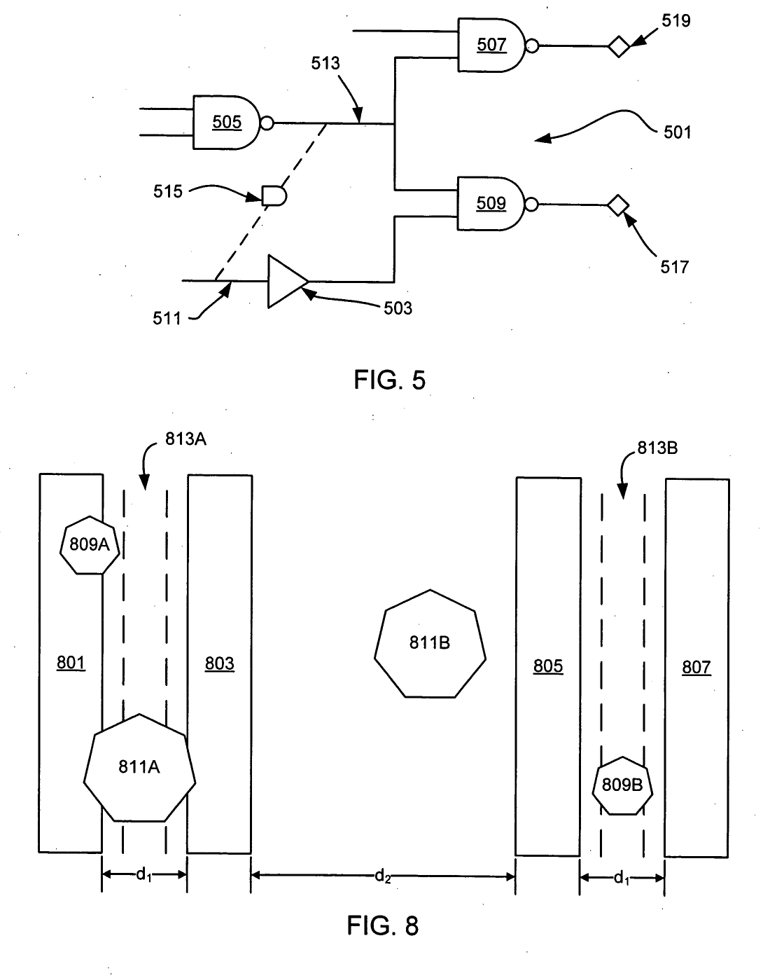

### DETAILED DESCRIPTION OF THE INVENTION

Overview

Different embodiments of the invention are directed to various tools and techniques that assist a manufacturing in developing tests for testing manufactured microdevices. As used herein, the term microdevice includes any device having physical features of 100 micrometers or less in size, including, but not limited to, microcircuits, thin film structures such as magnetic disk drive heads, gene chips, and microelectromechanical systems (MEMS).

According to different embodiments of the invention, a defect identification tool is employed to predict locations at which defects in a microdevice are more likely to occur. The tool may identify both a type of defect and the circuit location (by, e.g. naming the particular netlist or netlists corresponding to the circuit location) at which that defect is more likely to occur. A test circuit generation tool can then subsequently use this defect information to generate a test circuit that tests for the defect in the identified portions of the microcircuit. Similarly, an automatic test pattern generation tool may use the defect location information to generate test data custom-tailored to check for faults corresponding to the identified defect in the specified portions of the microcircuit. Advantageously, various embodiments of the invention may be used both to identify the locations at which defects caused by systematic errors, such as manufacturing process variations, are more likely to occur as well as the locations at which randomly-created defects are more likely to occur

Defect Location Identification Tool

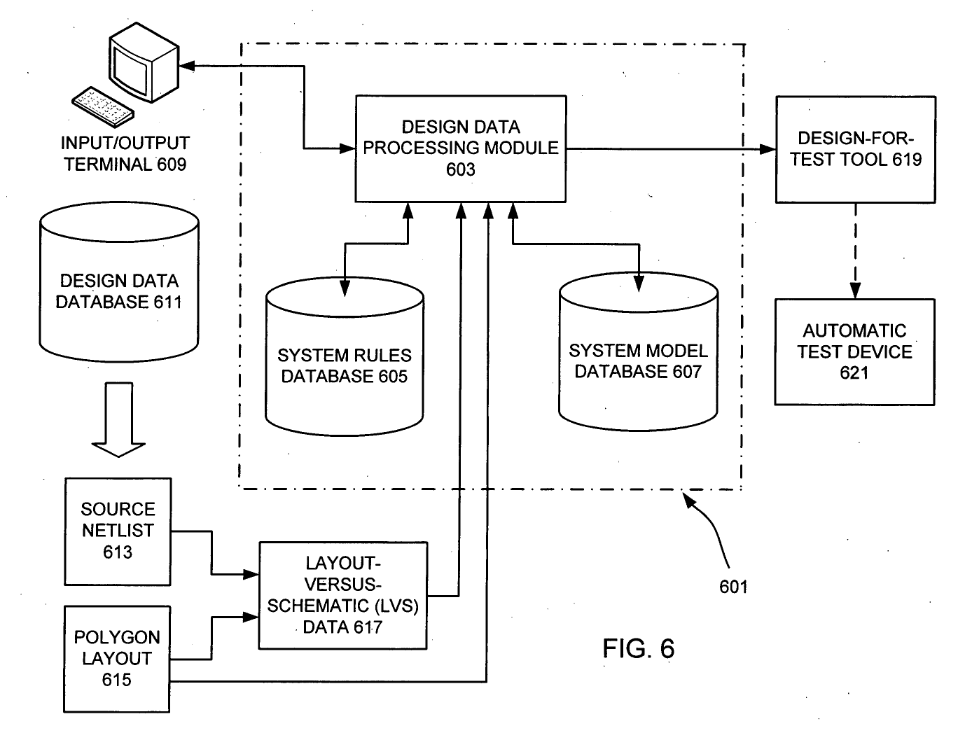

FIG. 6 illustrates a defect location identification tool 601 that may be provided according to various embodiments of the invention. As seen in figure, the tool 601 includes a design data processing module 603, a system rules database 605, and a system model database 607. With some examples of the invention, the defect location identification tool 601 optionally may also include an input/output terminal 609.

The design data processing module 603 is a processing tool that can be used to manipulate design data in a design for a microdevice. For example, the design data processing module 605 may be a programmable computer executing instructions for manipulating microdevice design data input into the programmable computer. According to various embodiments of the invention, for example, the design data processing module 605 may be implemented by a programmable computer executing the CALIBRE® verification and manufacturability software tools available from Mentor Graphics® Corporation of Wilsonville, Oreg.

More particularly, the functionality and operation methods ascribed to the design data processing module 603 may be performed by one or more software modules executing on a programmable computer. The instructions making up these software modules may be, for example, stored on and retrieved from a permanent or semi-permanent storage medium, such as a solid state memory device embodying a read-only memory (ROM) or a readable and writable memory (RAM), a magnetic memory device, such as a magnetic storage disk, an optical memory device, such as a CD or DVD disk, or a “punched” storage medium. Further, the instructions may be obtained directly from the storage medium, or transferred over any desired communication medium, such as a public network (e.g., the Internet) or a private network, via an infrared, visual or sonic communication device, or by any other type of suitable communication technique. Of course, still other embodiments of the invention may be implemented using a hardware device rather than software executing on a programmable computer, or a combination of the two.

As will be discussed in more detail below, the system rules database 605 provides rules and/or criteria under which the system will be simulated. The system model database 607 then provides modeling information for simulating the operation of a system, such as a lithographic manufacturing process. The defect location identification tool 601 uses both the rules and/or criteria and the system model to simulate the operation of the system on a microdevice design. Based upon the results of the system model simulation, the design data processing module 603 can determine the probability that particular physical characteristics of the microdevice will lead to a defect when the microdevice is manufactured in the actual system. Using this information, the design data processing module 603 can determine which locations on a designed microdevice will be the most likely to have defects when manufactured, and the type of those defects.

The defect information determined by the design data processing module 603 may then be provided to the design for test tool 619. The design for test tool 619 may be, for example, a conventional test generation tool or an automatic test pattern generation (ATPG) tool, as described above, or a combination of a conventional test generation tool and automatic test pattern generation tool. Similarly, the automatic test device 621 may be any conventional tool used to test a microdevice. The construction and use of each these tools are well known in the art. For example, various testing techniques employing implementations of these tools are described in the following articles, each of which are incorporate entirely herein by reference.
1. Janusz Rajski, Kan Thapar: “Nanometer Design: What are the Requirements for Manufacturing Test?” DATE 2004: 930-937;
2. Janusz Rajski, Nilanjan Mukherjee, Jerzy Tyszer, Thomas Rinderknecht: Embedded Test for Low Cost Manufacturing. VLSI Design 2004: 21-23 2003;
3. Zhiyuan Wang, Malgorzata Marek-Sadowska, Kun-Han Tsai, Janusz Rajski: Multiple Fault Diagnosis Using n-Detection Tests. ICCD 2003;
4. Janusz Rajski, Jerzy Tyszer: Test Data Compression and Compaction for Embedded Test of Nanometer Technology Designs. ICCD 2003;
5. Brady Benware, Chris Schuermyer, Sreenevasan Ranganathan, Robert Madge, Prabhu Krishnamurthy, Nagesh Tamarapalli, Kun-Han Tsai, Janusz Rajski: Impact of Multiple-Detect Test Patterns on Product Quality. ITC 2003: 1031-1040;
6. Frank Poehl, Matthias Beck, Ralf Arnold, Peter Muhmenthaler, Nagesh Tamarapalli, Mark Kassab, Nilanjan Mukherjee, Janusz Rajski: Industrial Experience with Adoption of EDT for Low-Cost Test without Concessions. ITC 2003: 1211-1220;
7. Janusz Rajski: Test Challenges of Nanometer Technology. ITC 2003: 13-22;
8. Zhiyuan Wang, Kun-Han Tsai, Malgorzata Marek-Sadowska, Janusz Rajski: An Efficient and Effective Methodology on the Multiple Fault Diagnosis. ITC 2003: 329-338;
9. Janusz Rajski, Jerzy Tyszer, Chen Wang, Sudhakar M. Reddy: Convolutional Compaction of Test Responses. ITC 2003: 745-754;
10. Irith Pomeranz, Janusz Rajski, Sudhakar M. Reddy: Finding a Common Fault Response for Diagnosis during Silicon Debug. DATE 2002: 1116;
11. Chen Wang, Sudhakar M. Reddy, Irith Pomeranz, Xijiang Lin, Janusz Rajski: Conflict driven techniques for improving deterministic test pattern generation. ICCAD 2002: 87-93;
12. Nadir Z. Basturkmen, Sudhakar M. Reddy, Janusz Rajski: Improved Algorithms for Constructive Multi-Phase Test Point Insertion for Scan Based BIST. VLSI Design 2002;
13. Janusz Rajski: DFT for High-Quality Low Cost Manufacturing Test. Asian Test Symposium 2001;
14. Xijiang Lin, Janusz Rajski, Irith Pomeranz, Sudhakar M. Reddy: On static test compaction and test pattern ordering for scan designs. ITC 2001: 1088-1097;
15. John T. Chen, Jitendra Khare, Ken Walker, Saghir Shaikh, Janusz Rajski, Wojciech Maly: Test response compression and bitmap encoding for embedded memories in manufacturing process monitoring. ITC 2001: 258-267;
16. Kuo-Hui Tsai, Tompson, Janusz. Rajski, Malgorzata Marek-Sadowska: STAR-ATPG: a high speed test pattern generator for large scan designs. ITC 1999: 1021-1030;
17. Graham Hetherington, Tony Fryars, Nagesh Tamarapalli, Mark Kassab, Abu Hassan, Janusz Rajski: Logic BIST for large industrial designs: real issues and case studies. ITC 1999: 358-367;
18. Janusz Rajski, Jerzy Tyszer: Diagnosis of Scan Cells in BIST Environment. IEEE Trans. Computers 48(7): 724-731 (1999);
19. Aiman El-Maleh, Mark Kassab, Janusz Rajski: A Fast Sequential Learning Technique for Real Circuits with Application to Enhancing ATPG Performance. DAC 1998: 625-631; and
20. Janusz Rajski, Jerzy Tyszer: Modular logic built-in self-test for IP cores. ITC 1998.
   Accordingly, these tools will not be discussed here in further detail. It should be appreciated, however, that while FIG. 6 illustrates the design for test tool 619 and the automatic test device 621 as separate from the defect location identification tool 601, various alternate embodiments of the invention may incorporate one or more of these tools.

The defect location identification tool 601 may also optionally include the input/output terminal 609. As will be appreciated by those of ordinary skill in the art, the input/output terminal 609 may be used to control the operation of one or more components of the tool 601. It also may additionally or alternately be used to view the results of the operation of any of the components of the tool 601. Still further, with various embodiments of the invention, the input/output terminal 609 may be used to interact with one or more of the design data database 611, the design for test tool 619, and the automatic test device 621.

The defect location identification tool 601 may receive the design for the microdevice from, for example, a database such as the design data database 611 shown in FIG. 6. If the microdevice is a microcircuit, then the design data database 611 may provide a source netlist for the microcircuit. As will be appreciated by those of ordinary skill in the art, the source netlist will specify the electrical connections between the components of the microcircuit. The netlist may also include additional information relating to the microcircuit, such as, e.g., timing parameters for one or more portions of the microcircuit. The design data database 611 can provide polygon layout data 615 as well. This type of data describes the physical shapes and positions of the polygons used to manufacture the microcircuit structure during, e.g., a photolithographic manufacturing process.

With the defect location identification tool 601 illustrated in FIG. 6, layout-versus schematic data 617 is created from the source netlist 613 and the polygon layout data 615. The layout-versus schematic data 617 describes the relationships between the functional components described in the source netlist 613 and the geometric information described in the polygon layout data 615. For example, for a component described in the source netlist 613, the layout-versus schematic data 617 will identify the position and shape of the polygons described in the polygon layout data 615 used to form that component. Alternately or additionally, for a polygon described in the polygon layout data 615, the layout-versus schematic data 617 will identify the component in the source netlist 613 that will be manufactured using the polygon.

It should be noted that the design data database 611 may provide data in a variety of formats used to design different aspects of microdevices. For example, the design data database 611 may include design information for a microcircuit in the form of a netlist, which abstractly describes electrical connections between components of the microcircuit. The design data database 611 may also, for example, store and translate design information into and from any desired format, such as GDSII, OASIS, OAC, Genesis, Apollo, GL1, SPICE, Verilog, VHDL, CDL, and Milkyway, among others.

According to some embodiments of the invention, the layout-versus schematic data 617 may be generated separately from the defect location identification tool 601, and be subsequently provided to the design data processing module 603 as an integrated unit. With alternate embodiments of the invention, the source netlist 613 and the polygon layout data 615 can be provided to the defect location identification tool 601. The tool 601 will then generate the layout-versus schematic data 617 for its subsequent use.

As will be explained in more detail below, the system model database 607 contains data describing a model of a system that will be used during the manufacture of the microdevice. For example, the modeled system may be the operation of the manufacturing process itself. Such a model can be used to simulate the physical processes, such as lithography or etching, which will form the structures of the microdevice, and predict the physical dimensions of the structures that will be produced by these processes. Alternately, the modeled system may represent random environmental conditions to which the microdevice will be exposed during the manufacturing process. Such a model can be used to estimate the probability of the occurrence of certain kinds of random events, such as a particle falling on the wafer, and predict the impact of those events on the resulting structure of the microdevice. With some embodiments of the invention, the system model database 607 may contain data for modeling a system including any desired combination of systematic and random operations.

As will also be explained in detail below, the system rules database 605 includes various rules or criteria defining how the system will be simulated using the model data. More particularly, the systems rules database 605 includes constraints under which the system will be simulated. For example, if the system model database 607 includes data for modeling a process that uses a photomask to lithographically manufacture a microdevice, then the system rules database 605 may include data prescribing the points of the photomask for which the system will be simulated. Similarly, if the system model database 607 includes data for modeling the effect of ambient particles during an optical manufacturing process, then the systems rules database 605 may include data describing the specific particle distribution values that will be employed for the model during a simulation.

Lithographic Manufacturing Process Model

As previously noted, with various embodiments of the invention, the model data may describe a model of the operation of a manufacturing process, such as a lithographic manufacturing process. As will be appreciated by those of ordinary skill in the art, the ability of a lithographic manufacturing process to accurately reproduce the patterns on the photolithographic masks in a resulting microdevice will depend upon a variety of manufacturing parameters. In particular, the accuracy of the lithographic process will depend upon the intensity of the light or other radiation employed to activate the photoresist compared against the depth of focus for the optical system used to focus the illuminating radiation onto the photoresist. In an effort to improve the understanding and use of photolithographic manufacturing processes, various models have been developed to predict how accurately a photolithographic process can reproduce a desired structure in a substrate material. These include aerial imaging models and models which account for the chemical properties of the photoresist as well. Several simulators for lithographic processes are widely available, such as SPLAT and TEMPEST from the University of California at Berkeley, PROLITH from the company KLA-Tencor, Solid-C from the company Sigma-C, and EMSuite from Panoramic Technologies.

One model, the Variable Threshold Resist (VTR) model, has been used as a fast method for modeling both the aerial image behavior of a lithographic system and the behavior of the photoresist, using calibrations of the maximum light intensity (Imax) and the image contrast, or slope. More on the VTR model can be found in the the PhD dissertation of Nick Cobb [Fast Optical and Process Proximity Correction, Nicolas B. Cobb, U.C. Berkeley PhD Dissertaion, 1998] and extensions to the model can be found in the article by Y. Granik, N. Cobb, T. Do, “Universal Process Modeling with VTRE for OPC”, SPIE, 4691, pp. 377-394, 2002, each of which are hereby incorporated by reference.

The relationship between a projected image projected from a photomask and a final resist “image” or relief has been well-studied by those of ordinary skill in art, and has been the subject of many other published articles as well. For example, each of following articles (each of which is incorporated entirely herein by reference) discusses photolithographic manufacturing process models or information or techniques that may be employed to create manufacturing process models:
1. Y. Granik, “Correction for etch proximity: new models and applications”, Proc. SPIE Vol. 4346, pp. 98-112, (2001).
2. Y. Granik, “Dry etch proximity modeling in mask fabrication”, Proc. SPIE Vol. 5130, pp. 86-91, (2003).
3. J. Stirniman, M. Rieger, “Spatial-filter models to describe lithographic behavior”, SPIE, 3051, pp. 469-478, (1997).
4. D. Fuard, M. Besacier, P. Schiavone, “Assessment Of Different Simplified Resist Models”, SPIE, 4691, pp. 1266-1277, (2002).
5. N. Cobb, A. Zakhor, “A Mathematical And CAD Framework For Proximity Correction”, SPIE, 2726, 208-222, (1996).
6. B. Tollkühn, T. Fühner, D. Matiut, et. al. “Will Darwin's Law Help us to Improve our Resist Models?” Proc. SPIE. Vol. 5039, pp. 291-302 (2003).
7. S. G. Hansen “The Resist Vector: Connecting the Aerial Image to Reality”. Proc. SPIE Vol. 4690, pp. 366-380 (2003).
8. U.S. Pat. No. 6,643,616 B1 to Granik et al., entitled “Integrated Device Structure Prediction Based On Model Curvature,” issued Nov. 4, 2003.

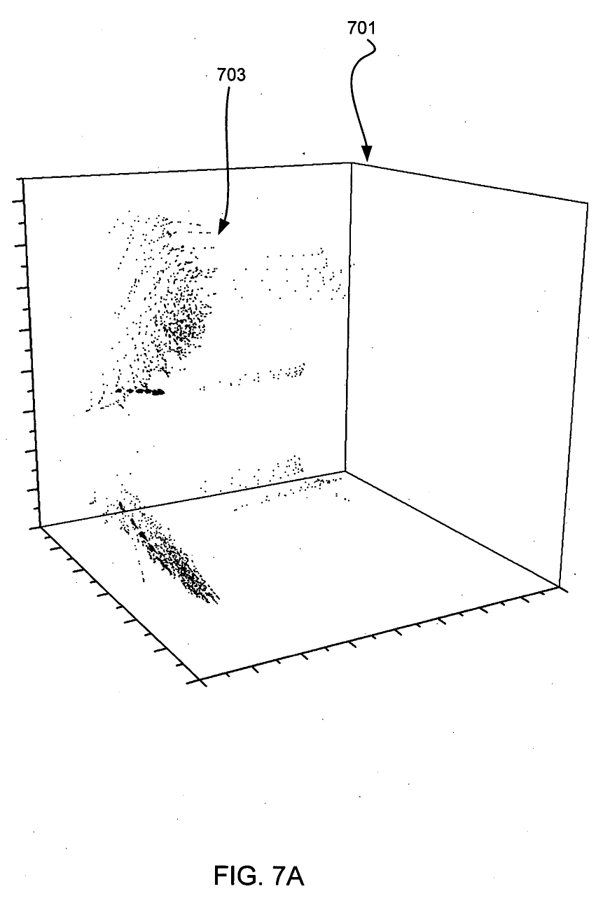

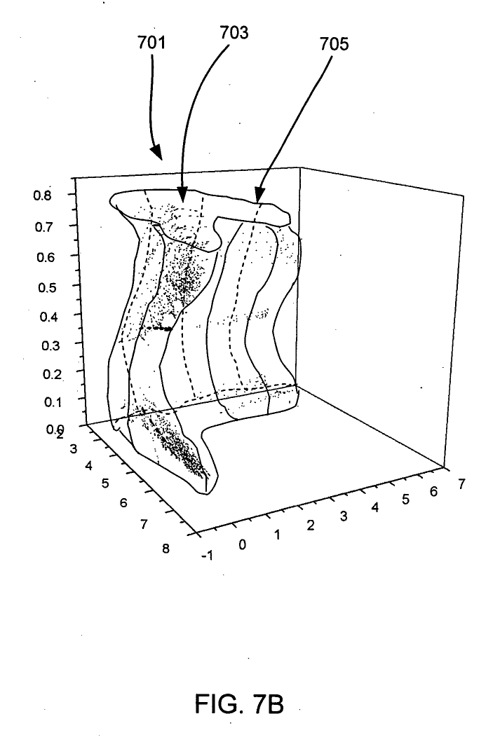

FIG. 7A illustrates a graph 701 plotting various mask structures against axes representing parameter values that may be employed in a photolithographic process. As shown in this chart, boundary points 703, at which the photolithographic process will not reliably create a desired structure in a substrate, can be determined from the data. Using this boundary information, a spatial model of a photolithographic process can be created, as shown in FIG. 7B. More particularly, as seen in this figure, the boundary points 703 can be used to plot a continuous or discontinuous surface of a volume or shape 705. If the parameters of a photolithographic process are all within this model shape 705, then the photolithographic process will accurately create the desired structure in a substrate. If, however, the manufacturing conditions are such that the parameters of the process fall outside of this volume 705, then the photolithographic process will not be able to reliably produce the desired structure in the substrate, and the resulting microdevice is likely to fail.

It should be noted that, with various embodiments of the invention, the system model contained in the system model database 607 can be calibrated to specific process parameters that will be used during the modeled lithographic process. Alternately, the model may be a generic model common to a range of different photolithographic process parameters. These parameters may include any desired parameters, such as, for example, physical features of the photolithographic mask, the intensity and depth of focus values used to image the photomask onto a layer of photoresist, chemical characteristics of the photoresist, and the time and chemical variables employed during the etch of the photoresist.

A generic model volume, which more generally describes the reliability of a photolithographic process over a range of possible parameters can also be generated. Thus, if a manufacturer is uncertain as to the specific parameters that will be used during the manufacturing process, the manufacturer can employ the generic model to predict the locations in which a defect in the microdevice is likely to occur during manufacture. While the generic model will have a volume difference from the calibrated model, resulting in a reduced accuracy in the simulated manufacture, the generic model will still provide a useful identification of the locations in the microdevice at which the effects are more likely to occur. Moreover, as of the manufacturer can determine one or more specific parameters for the manufacturing process, the manufacturer can apply the specific parameters to improve the accuracy of the process model.

In order to detect potential defects that may occur during the manufacture of a microdevice, the design data processing module 603 will obtain the photomask or polygon layout 615 for the microdevice from the design data database 611, as previously noted. Based upon the rules or criteria defined in the system rules database 605, the design data processing module 603 will then apply the system model data from the database 607 to the polygon information in the polygon layout 615. For example, the system rules database 605 may specify positions in the polygon layout 615 for which the operation of the modeled system will be simulated (sometimes referred to as a fragmentation data). The system rules database of 605 may also contain additional scripting rules for applying the modeled lithographic manufacturing process, such as any desired layer operations, the implementation of sub-resolution assist features (SRAF) or other photomask correction features (sometimes referred to as Optical and Process Correction (OPC)) to the polygon information, and the like.

By simulating the manufacture of the device using the system model from the system model database 607 and the polygon layout 615, the design data processing module 603 will produce a prediction of the resulting microdevice structure that would be formed by the modeled manufacturing process. By comparing this simulated output structure with the original polygon layout 617, the design data processing module 603 can identify discrepancies between the simulated microdevice and the original polygon layout 615. These discrepancies (e.g., where structures in the predicted microdevice bridge while the original polygon layouts do not) can then be used to identify locations in the microdevice design where a defect is likely to occur during manufacture.

For example, if a polygon in an the original layout design corresponds to two close but separate polygon structures in the simulated output, the design data processing module 603 may determine that a shorting defect is likely to occur with the polygon in the original design layout. Likewise, if two separate polygons in the original design layout correspond with a single polygon structure in the simulated output, then the design data processing module 603 may determine that a bridging defect is likely to occur between the two polygons in the original design layout.

Once the design data processing module 603 has identified the physical locations of these predicted defects, the design data processing module 603 can then employ the layout-versus-schematic data 617 to identify netlists of the circuit portions corresponding to the defects. This can be determined in a number of ways, either by identifying the netlists that correspond to the affected polygons themselves, or by determining which netlists are electrically connected to the structures represented by those polygons.

As previously noted, the design data processing module 603 can then provide the names of these netlists to the design for test tool 619. The design-for-test tool 619 typically takes prioritized netlists as input to determine where to insert the test structures into the microdevice design, or, alternately or additionally, how to configure test data patterns. Placing these test structures in the netlists more likely to have defects upon manufacture helps to ensure that these netlists will be fully tested in the manufactured microdevice. Similarly, creating specific test patters to test the netlists more likely to have defects upon manufacture helps to ensure that these netlists will be fully tested in the manufactured microdevice.

Still further, with various embodiments of the invention, the design data processing module 603 can alternately or additionally provide a specific geographical location where defects are likely to occur, which may be useful with some test algorithms to more accurately test the manufactured microdevice. Moreover, while the various embodiments of the invention have been described as passing the design for test tool 619 defect information corresponding to a netlist format, it should be appreciated that various embodiments of the invention may provide the design for test tool 619 with data in any desired format. For example, if the design for test tool 619 accepts layout design data, then various embodiments of the invention may directly identify portions of a layout design more likely to have defects upon manufacture to the design for test device, without determining the netlist or netlists corresponding to those portions of the layout design.

It also should be appreciated that, while the use of lithographic manufacturing models have been described in detail above, any desired manufacturing process model may be employed by the invention, including models for a beam manufacturing process (such as, e.g., an electron beam manufacturing process) or a combination of lithographic and. Also, while a model has been generically described as a physical volume and graphically illustrated in FIGS. 7A and 7B, it should be appreciated than any desired type of abstract, mathematical or non-graphical model may also be employed according to various embodiments of the invention.

Critical Area Process Model

As also previously discussed, various embodiments of the invention may employ system model data to model how environmental factors may cause random defects in a microdevice during a manufacturing process. For example, some embodiments of the invention may employ statistical data to model bridging defects caused by ambient particles coming to rest on the photomask or wafer during the manufacturing process.

An illustration of how such a model for predicting susceptibility to particle induced defects may be generated is shown in FIG. 8. More particularly, FIG. 8 illustrates four parallel connection lines 801-807. The connection line 801 is spaced at a distance d₁ from the connection line 803. Similarly, the connection line 805 is spaced at a distance d₁ from the connection line 807. Connection lines 803 and 805 are then separated by a distance d₂ that is greater than the distance d₁. As will be appreciated by those of ordinary skill in the art, particles in the atmosphere during the manufacturing process can damage or even destroy the functionality of adjacent connection lines. For example, a particle contacting two adjacent connection lines may bridge the lines, causing them to work improperly. For this reason, manufacturers strictly control the number and size of particles in their microcircuit fabrication rooms.

The likelihood of this type of bridging fault occurring in a pair of adjacent connection lines depends upon the number of particles, the size of the particles, and the distance between the adjacent connection lines. As shown in FIG. 8, particles 809 have a smaller width than the distance d₁, and thus cannot create a bridge between any of the connection lines 801-807. Larger particles 811, however, are wider than distance d₁. Accordingly, because the width of a particle 811 is smaller than distance d₂, a particle 811 will not create a bridge between connection lines 803 and 805. If, however, a particle 811 falls within an area 813 between connection lines 801 and 803 or between 805 and 807, then the particle 811 will bridge the adjacent connection lines. Thus, the area 813 is sometimes referred to as the “critical area” for particle of the same size or larger than particles 811.

By determining the amount of critical area in a microdevice structure for a variety of particle sizes, and then determining the statistical distribution of those different particles sizes during the manufacturing process, a model may be constructed that will estimate how frequently the particles will cause a bridging defect in that structure during its manufacture. Various techniques for creating critical area analysis models are known in the art, and may be found in numerous published articles, such as
1. G. A. Allan, A. J. Walton, “Efficient Critical Area Algorithms and Their Application to Yield Improvement and Test Strategies”, 1994 IEEE International Workshop on Defect and Fault Tolerance in VLSI Systems, 17-19 Oct. 1994, Montreal, pp 88-96 (1994);
2. G. A. Allan, A. J. Walton; “Efficient Extra Material Critical Area Algorithms”, IEEE Transactions on Computer-Aided Design of Integrated Circuits and Systems, 18, No 10, pp. 1480-1486, October 1999, ISSN 0278-0070. [RAE2001:Allan02];
3. G. A. Allan, A. J. Walton; “Critical Area Extraction of Extra Material Soft Faults”, IEEE Transactions on Semiconductor Manufacturing, 11, No 1, pp. 146-154, February 1998, ISSN 0894-6507. [RAE2001:Allan03];
4. M. P. C. Chia, G. A. Allan, A. J. Walton; “Photolithography Expert System for Improved Estimation of IC Critical Area”, SPIE Conference on Microelectronic Manufacturing, Yield, Reliability and failure Analysis, pp. 74-81, 23-24 Sep. 1998. G. A. Allan, A. J. Walton; “Efficient Critical Area Estimation for Arbitrary Defect Shapes”, IEEE International Symposium on Defect and Fault Tolerance in VLSI Systems, pp. 20-28, October 1997;
5. G. A. Allan, A. J. Walton; “Automated Redundant Via Placement for increased Yield and Reliability”, Proc. of SPIE, Microelectronic Manufacturing Yield, Reliability and Failure Analysis III, pp. 114-124, 1-2 Oct. 1997;
6. G. A. Allan, A. J. Walton; “Efficient Critical Area Measurements of IC Layout Applied to Quality and Reliability Enhancement”, Microelectronics and Reliability, 37, No 12, pp. 1825-1833, 1997, ISSN 0026-2714;
7. G. A. Allan, A. J. Walton; “Sampling based yield prediction for ULSI”, SPIE Symposium on Microelectronic Manufacture, pp. 198-209, October 1996;
8. G. A. Allan, A. J. Walton; “Fast Yield Prediction for Accurate Costing of ICs”, 1996 IEEE International Conference Innovative Systems In Silicon, pp. 279-287, October 1996;
9. T. G. Waring, G. A. Allan, A. J. Walton; “Integration of DFM Techniques and Design Automation”, IEEE International Symposium on Defect and Fault Tolerance in VLSI Systems, pp. 59-67, November 1996;
10. G. A. Allan, A. J. Walton; “Yield Prediction by Sampling with the EYES Tool”, IEEE International Symposium on Defect and Fault Tolerance in VLSI Systems, pp. 39-47, November 1996;
11. G. A. Allan, A. J. Walton; “Yield Prediction for ULSI”, VLSI Multi-Level Interconnect Conference, No, pp. 207-212, June 1996;
12. G. A. Allan, A. J. Walton; “Critical Area Extraction of Extra Material Soft Faults”, DTF 95, pp. 55-62, November 1995;
13. G. A. Allan, A. J. Walton; “Hierarchical Critical Area Extraction with the EYE tool”, DTF 95, pp. 28-36, November 1995;
14. G. A. Allan, A. J. Walton; “A Defect Sensitivity Measurement Tool Enabling Comparison of IC Layout Sensitivity”, VLSI Multi-Level Interconnect Conference, pp. 655-657, June 1995;
15. G. A. Allan, A. J. Walton; “Efficient Critical Area Measurements of IC Layout Applied to Quality and Reliability Enhancement.”, ESREF 95, pp. 77-82, 3-6 Oct. 1995;
16. A. J. Walton, M. Fallon, M. I. Newsam, R. S. Ferguson, D. Sprevak, G. A. Allan, J. P. Elliott; “Procedures for the Development of Manufacturable IC Processes”, MICRO 95, pp. 208-213, 17-19 Jul. 1995;
17. G. A. Allan, J. P. Elliott, A. J. Walton; “EYE: A Tool for Measuring the Defect Sensitivity of IC Layout”, IEE Colloquium on Improving the Efficiency of IC Manufacturing Technology, No 1995/153, pp. 5/1-5/4, 12 Apr. 1995;
18. G. A. Allan, A. J. Walton; “Efficient Critical Area Algorithms and Their Application to Yield Improvement and Test Strategies”, 1994 IEEE International Workshop on Defect and Fault Tolerance in VLSI Systems, pp. 88-96, 17-19 Oct. 1994;
19. G. A. Allan, A. J. Walton, R. J. Holwill; “A Yield Improvement Technique for IC Layout using Local Design Rules”, IEEE Transactions on Computer-Aided Design of Integrated Circuits and Systems, No 11, pp. 1355-1362, November 1992; and
20. G. A. Allan, A. J. Walton, R. J. Holwill; “Yield Improvement with Local Design Rules”, IEEE Workshop on Defect and Fault Tolerance In VLSI Systems, pp. 82-90, 5-7 Nov. 1990;
   each of which are incorporated entirely herein by reference.

The particle size and distribution values may be graphically represented by, e.g., a bell-type curve showing the number of particles per cubic foot of space that are smaller than one micron, the number of particles per cubic foot of space that are between one and five microns in size, the number of particles per cubic foot of space that are between five and ten microns in size, etc. The statistics on these particles may be generated from hypothetical data on process conditions, or may be derived from measurements taken in a fabrication facility using conventional wafer and reticle inspection machines, such as those manufactured by KLA-Tencor and others.

The design data processing module 603 can then use this type of model can to identify particular locations in a microdevice design that are likely to cause a particle-type bridging defect during its manufacture. Again, using the layout-versus-schematic data 617, the design data processing module 603 can then determine the specific netlists that contain these locations, and then identify these netlists to the design-for-test tool 619, to ensure that these netlists are properly tested for bridging defects.

Rule-Based Modeling Tools

With various embodiments of the invention, the tool 601 may even omit the use of a model which generates simulated results to predict defects. Instead, these embodiments of the invention may use rules to determine the probability that a given set of physical characteristics will produce a defect in the microdevice. For example, a critical area analysis model may indicate that a bridge defect is likely to occur with a 90% probability when two wiring lines run within 0.75 microns of each other for a length of more than 10 microns. The defect model data may additionally indicate that a bridge defect is likely to occur with only a 1% probability when two wiring lines are separated by a distance of more than 0.75 microns from each other for a length of more than 10 microns. Based upon this defect model data, geometric criteria and/or rules may be generated specifically to identify wiring lines in a microdevice design that run within 0.75 microns of each other for a length of more than 10 microns. Accordingly, various embodiments may employ rules or other criteria in lieu of (or in addition to) simulating the manufacture of a microdevice design using a model.

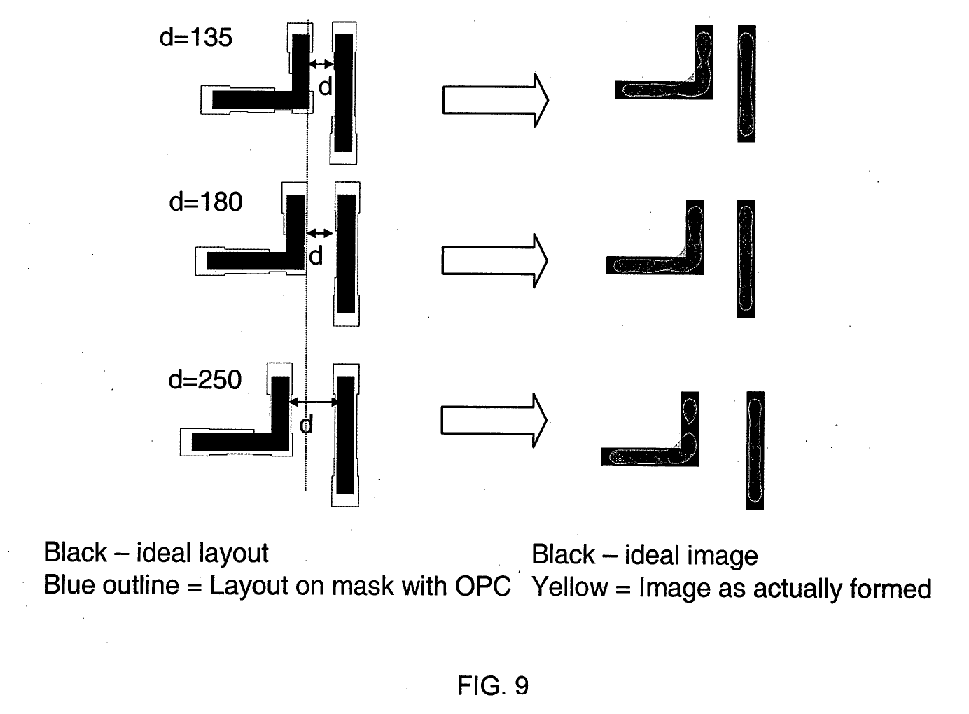

The detection of “forbidden pitches” is another example of where various embodiments of the invention may employ a rule-based approach to determining potential defect locations instead of or in addition to using a model to simulate the manufacture of a microdevice design. Forbidden pitches are common when using lithographic systems with off-axis illumination. FIG. 9 provides an example of this phenomenon, in which certain spacings (and not simply a minimum space rule) between structure features may cause those features to be improperly formed. These pitches can be characterized by straightforward rules, which may, for example, define the specific pitches and spacing combinations that do not manufacture well. The design data processing module 603 can then use these rule to identify or tag the portions of a layout design containing those pitches as potential defect locations. Thus, with the example described immediately above, geometric criteria may be reliably used to identify physical characteristics of a microcircuit that have a 90% probability of causing a defect without employing the defect model data.

According to still other embodiments of the invention, the optional input/output terminal 609 may be employed to control the use of the geometric criteria/rules and/or the defect model data. For example, the defect model data may state: (i) that that a bridge defect is likely to occur with a 90% probability when two wiring lines run within 1.0 microns of each other for a length of more than 10 microns, (ii) that a bridge defect is likely to occur with a 60% probability when two wiring lines run within 1.0 to 1.5 microns of each other for a length of more than 10 microns, and (iii) that that a bridge defect is likely to occur with a 30% probability when two wiring lines run within 1.5 to 2.0 microns of each other for a length of more than 10 microns.

With this example, a user of the tool may only be concerned with physical characteristics that have, for example, a 60% or larger probability of causing a defect. In this situation, the manufacturer may employ the input/output terminal 409 to instruct the system rules database 405 (or the design data processing module 403) to ignore rules or criteria that identify physical characteristics that have less than a 60% probability of causing a defect. Thus, the user could instruct the design data processing module to ignore defect model data relating to item (iii) above. Advantageously, this use of the input/output terminal 409 allows a manufacturer to identify only those locations within a microcircuit with a desired probability of having a defect.

Further Embodiments of the Design for Manufacturing and Test Tool

While the particular embodiments of the invention discussed above specifically describe the identification of likely bridging defect locations in a microdevice, it should be appreciated that various embodiments of the invention may be employed to identify the location of any type of unintended physical defect in a microdevice. For example, different model data may be employed to identify locations where necking, contact non-overlap, shorting or any other unintended physical defect is likely to occur.

Also, various embodiments may employ information produced by device testing to improve the accuracy with which defect locations are predicted. For example, a test process may identify a bridging fault in a particular structure of a microdevice. With various embodiments of the invention, the physical features of this defective structure may be incorporated into the system model database 607, in order to more accurately predict the likelihood of a defect occurring in this type of structure in the future.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A method of identifying potential defect locations in a microdevice design, comprising:
receiving a microdevice design;
simulating manufacturing of at least a portion of the microdevice using a model of a system to which the microdevice would be exposed during manufacturing, so as to produce simulated manufacturing data for the microdevice; and
comparing the simulated manufacturing data with the microdevice design to identify potential defect locations in the microdevice design.

2. The method recited in claim 1, wherein the system would randomly create defects in the microdevice during manufacturing of the microdevice.

3. The method recited in claim 2, wherein the system describes the contact of ambient particles with a reticule during a photolithographic process.

4. The method recited in claim 1, wherein the system would systematically create defects in the microdevice during manufacturing of the microdevice.

5. The method recited in claim 4, wherein the system describes limitations in an optical manufacturing process.

6. The method recited in claim 1, wherein the system describes limitations of a manufacturing process.

7. The method recited in claim 1, wherein the system describes environmental effects during a manufacturing process.

8. The method recited in claim 1, further comprising:
receiving system rules or criteria defining constraints for implementing the model of the system; and
simulating manufacturing of the microdevice based upon the received system rules or criteria.

9. The method recited in claim 8, wherein the rules define specific portions of microdevice design for which manufacturing is simulated using the model of the system.

10. The method recited in claim 1, further comprising identifying potential defect types in the microdevice design.

11. The method recited in claim 10, wherein the identified potential defect types include one or more defect types selected from the group consisting of a bridging defect, a shorting defect, a necking defect, and a contact non-overlap defect.

12. The method recited in claim 1, further comprising identifying a potential defect location in the microdevice design by identifying one or more netlists containing the potential defect.

13. The method recited in claim 1, further comprising identifying a potential defect location in the microdevice design by identifying a geographical location of the potential defect relative to the microdevice design.

14. A tool for identifying potential defect locations in a microdevice, comprising:
a system model database containing a model of a system to which a microdevice would be exposed during manufacturing; and
a design data processing module that
simulates manufacturing of a received microdevice design using the model of the system contained in the system model database, so as to produce simulated manufacturing data for the microdevice, and
compares the simulated manufacturing data with the received microdevice design to identify potential defect locations in the microdevice design.

15. The tool recited in claim 14, wherein the system would randomly create defects in the microdevice during manufacturing of the microdevice.

16. The tool recited in claim 15, wherein the system describes the contact of ambient particles with a reticule during a photolithographic process.

17. The tool recited in claim 14, wherein the system would systematically create defects in the microdevice during manufacturing of the microdevice.

18. The tool recited in claim 17, wherein the system describes limitations in an optical manufacturing process.

19. The tool recited in claim 14, wherein the system describes limitations of a manufacturing process.

20. The tool recited in claim 14, wherein the system describes environmental effects during a manufacturing process.

21. The tool recited in claim 14, further comprising a system rules database containing rules or criteria defining constraints for implementing the model of the system during simulation of manufacturing of the microdevice design.

22. The tool recited in claim 21, wherein the rules define specific portions of the microdevice design for which the design data processing module simulates manufacturing of the microdevice.

23. The tool recited in claim 14, wherein the design data processing module further identifies potential defect types in the microdevice design.

24. The tool recited in claim 23, wherein the design data processing module identifies potential defect types include one or more defect types selected from the group consisting of a bridging defect, a shorting defect, a necking defect, and a contact non-overlap defect.

25. The tool recited in claim 14, wherein the design data processing module identifies a potential defect location in the microdevice design by identifying one or more netlists containing the potential defect.

26. The tool recited in claim 14, wherein the design data processing module identifies a potential defect location in the microdevice design by identifying a geographical location of the potential defect relative to the microdevice design.
